(19) United States
(12) Patent Application Publication
(10) Pub. No.: US 2017/0030179 A1
(43) Pub. Date: Feb. 2, 2017

(54) HYDRAULIC FRACTURING AND FRAC-PACKING USING ULTRA LIGHT, ULTRA STRONG (ULUS) PROPPANTS

(71) Applicant: STATOIL GULF SERVICES LLC, Houston, TX (US)

(72) Inventors: Pandurang M. KULKARNI, Richmond, TX (US); Desikan SUNDARARAJAN, Sugar Land, TX (US); Virgil Ray ELLIS, Katy, TX (US); Endre IVARRUD, Houston, TX (US)

(73) Assignee: STATOIL GULF SERVICES LLC, Houston, TX (US)

(21) Appl. No.: 14/815,666

(22) Filed: Jul. 31, 2015

(51) Int. Cl. E21B 43/267; C09K 8/80; E21B 43/26

(52) U.S. Cl. CPC E21B 43/267; E21B 43/26; C09K 8/80

(57) ABSTRACT

A method of fracturing or frac-packing a subterranean zone surrounding a well bore includes fracturing the subterranean zone with a fracturing fluid to form fractures; pumping proppant slurry comprising ultra-light, ultra-strong proppant into the fractures of the subterranean zone; and releasing pressure after pumping to form propped fractures.

### STATEMENT AS TO RIGHTS TO INVENTIONS MADE UNDER FEDERALLY SPONSORED RESEARCH OR DEVELOPMENT

The invention described herein was made in the performance of work under a NASA contract and is subject to the provisions of Public Law 96-517 (35 U.S.C. §202) in which the Contractor has elected to retain title.

### BACKGROUND OF THE INVENTION

1. Field of the Invention

The present invention relates to methods of fracturing or frac-packing a subterranean zone surrounding a well bore with ultra-light, ultra-strong proppants. More specifically, the present specification relates to the use of ultra-light, ultra-strong proppants (i) in the stimulation and hydraulic fracturing treatment of an unconventional (shale and ultra-tight) reservoir and (ii) in the frac-packing treatment of a poorly consolidated conventional reservoir.

2. Description of Background Art

Induced hydraulic fracturing is a technique used to release oil and natural gas by creating and maintaining open fractures from a well bore drilled into reservoir rock formations. A hydraulically pressurized liquid (i.e., a “fracking fluid”) comprising water, chemicals, and a particulate proppant material is injected into the well bore to create cracks in the deep-rock formations through which oil and natural gas can flow more freely. Fractures may extend many meters and tens or even hundreds of meters from a main well bore from which they originate. When the hydraulic pressure is removed from the well, the proppant material prevents the induced fractures from closing. The process typically involves (i) injecting a fluid (i.e., a fracturing fluid) at high pressure to initiate a fracture in the rock and (ii) placing particulate material (i.e., a proppant) to keep the fracture open when the injection is stopped. Therefore, proppant design is one of the most important elements of a fracturing treatment.

The most commonly used fracking fluid is water with added chemicals and proppants. Typically, the proppants make up 5-15 volume % of the fracking fluid, chemicals make up 1-2 volume %, and the remainder is water. The chemicals added may comprise viscosifier agents and/or cross-linked polymers, often from natural vegetation like cellulose, that enhance the fracking fluid's ability to transport proppants into the reservoir and the fractures. Some chemicals also reduce the friction between the fracking fluid being pumped and the well conduits. Examples of suitable gelling agents are hydroxypropyl guars (of ionic or non-ionic type) and polyacrylamides.

The physical characteristics of the proppant material (e.g., particle size, particle size distribution, specific gravity, surface friction, and strength) have a significant impact on hydraulic fracturing operations and hydrocarbon recovery. A typical size of the proppant particles is a diameter of around 0.1 to 2 mm. Preferably, each particle is approximately spherical, and the size distribution of the particles is reasonably uniform to enable easy flow of the particles. The compressive strength of the particles must be very high in order for them to keep fractures open without being crushed. There may be a trade-off between the porosity and specific gravity of a proppant particle and its resistance to compressive stress. A proppant particle must have sufficient compressive strength to reduce the likelihood of it being crushed by a fracture attempting to close when the fracking fluid is no longer providing pressure in the fractured formation. In addition, the propensity to settling in the fracking fluid should be minimized (e.g., by making the proppant sufficiently light in weight).

Currently available proppants comprised of sand, resin-coated sand, ceramic, glass, or sintered bauxite are significantly denser than the fracking fluid, which results in faster settling and non-optimal distributions of the proppants within the fractures. Moreover, existing proppants demonstrate a degraded performance over time due to the production of “fines” (crushed fine particulates). The fines settle after removal of the fracking fluids and greatly reduce permeability to oil and natural gas.

The industry is looking into recovering oil from geologic landscapes that formerly were economically challenged (e.g., ultra-tight permeability reservoirs, often referred to as unconventional reservoirs or shale reservoirs). These reservoirs can contain hydrocarbons in the oil phase, gas phase, or both phases. The hydrocarbons in these reservoirs, however, may or may not actually be contained in true shales. In some cases, they are simply contained in very low permeability carbonates, siliciclastics, clays, or combinations thereof. A common attribute among this reservoir class is how they are typically developed. Many ultra-tight systems or shale reservoirs are economically developed using techniques such as horizontal wellbores and hydraulic fracturing to increase contact of the well with the formation. The Bakken formation is one example of such an ultra-tight reservoir or subterranean hydrocarbon bearing formation. However, even with these technological enhancements, these resources can be economically marginal and often only recover 5-15% of the original oil in place under primary depletion.

In low permeability shale and ultra-tight reservoirs, slickwater is commonly used as a fracturing fluid due to its ability to generate complex fractures and contact a large reservoir area. The low viscosity and high density contrast of slickwater with conventional (sand/ceramic) proppants lead to faster settling and poor proppant transport in both hydraulic and dilated natural fractures. The resulting sub-optimal distribution of proppants and permeability in fractures result in faster production decline and lower hydrocarbon recovery per well. Since the well-spacing is determined based on propped length, a poor proppant coverage invites lower well-spacing and increased number of wells per acre. Furthermore, from an operational point of view, to reduce the risk of screen-outs, conventional proppants require the use of large volumes of water. Thus, hydro-fracturing with slickwater results in sub-optimal hydrocarbon recovery and significant drilling costs. Therefore, there is an industry-wide need for a method for recovering hydrocarbons from unconventional reservoirs, which maximize the recovery from these formerly challenged reservoirs.

As such, proppant materials are needed that have a low density close to the density of water while maintaining a high strength to withstand closure stresses, resulting in increased oil and natural gas well productivity. Proppants are an expensive part of a fracking operation, requiring the use of a large amount of water and chemicals to maintain a dispersion of proppants. Reducing the density of the proppants while retaining adequate strength would allow the reduction of water and/or chemicals consumption and in addition provide a means to transport a treatment chemical into the fractures containing the hydrocarbons or in proximity of the hydrocarbons to be produced.

### SUMMARY OF THE INVENTION

The first embodiment of the present invention is directed to a method of fracturing a subterranean zone surrounding a well bore, comprising the steps of fracturing the subterranean zone with a fracturing fluid to form fractures; pumping proppant slurry comprising ultra-light, ultra-strong proppant into the fractures of the subterranean zone; and releasing pressure after pumping to form propped fractures. The ultra-light, ultra-strong proppant may have a specific gravity between 1.0-3.0 and a crush strength of 10,000 psi or higher. The subterranean zone may be a shale zone, may have a matrix permeability of 1 mD or less. The ultra-light, ultra-strong proppant may comprise spherical particles comprising a material selected from the group consisting of oxides, nitrides, oxynitrides, borides, and carbides. The oxides may be SiO₂, Al₂O₃, Fe₂O₃, CaO, MgO, FeO, Fe₃O₄, MnO, yttria-stabilized zirconia, or CaCO₃. The nitrides may be Li₂SiN₂, CaSiN₂, MgSiN₂, or Si₃N₄. The oxynitrides may be Si_{6-z}Al_{z}O_{z}N_{8-z} where 0<z<5. The borides may be MgB₂. The carbides may be SiC. The ultra-light, ultra-strong proppant may comprise spherical particles that have a porosity of about 10 to 60%. The ultra-light, ultra-strong proppant may comprise spherical particles that have a hollow core.

The second embodiment of the present invention is directed to a method of frac-packing a subterranean zone surrounding a well bore, comprising the steps of fracturing the subterranean zone with a fracturing fluid to form fractures; pumping proppant slurry comprising ultra-light, ultra-strong proppant into the fractures of the subterranean zone; and releasing pressure after pumping to form propped fractures. The ultra-light, ultra-strong proppant may have a specific gravity between 1.0-3.0 and a crush strength of 10,000 psi or higher. The subterranean zone may be a poorly consolidated zone, may have a matrix permeability of 10 D or less. The ultra-light, ultra-strong proppant may comprise spherical particles comprising a material selected from the group consisting of oxides, nitrides, oxynitrides, borides, and carbides. The oxides may be SiO₂, Al₂O₃, Fe₂O₃, CaO, MgO, FeO, Fe₃O₄, MnO, yttria-stabilized zirconia, or CaCO₃. The nitrides may be Li₂SiN₂, CaSiN₂, MgSiN₂, or Si₃N₄. The oxynitrides may be Si_{6-z}Al_{z}O_{z}N_{8-z} where 0<z<5. The borides may be MgB₂. The carbides may be SiC. The ultra-light, ultra-strong proppant may comprise spherical particles that have a porosity of about 10 to 60%. The ultra-light, ultra-strong proppant may comprise spherical particles that have a hollow core.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to one of ordinary skill in the art from this detailed description.

### BRIEF DESCRIPTION OF THE DRAWINGS

The present invention will become more fully understood from the detailed description given below and the accompanying drawings that are given by way of illustration only and are thus not limitative of the present invention.

FIG. 1 is an illustration to explain tight to ultra-tight hydrocarbon-bearing subterranean formations.

FIG. 2 is a diagrammatic view of an example of a hydrocarbon-bearing subterranean formation to which the present invention is applicable.

### DETAILED DESCRIPTION OF THE INVENTION

The present invention will now be described with reference to the accompanying drawings.

The present invention is directed to methods of fracturing or frac-packing a subterranean zone surrounding a well bore. More specifically, the present invention is directed to a method of fracturing or frac-packing a subterranean zone surrounding a well bore by using ultra-light, ultra-strong proppants. Specific elements of the method, such as the steps to implement the method and injection and production conditions, are discussed below. The method involves pumping proppant slurry comprising ultra-light, ultra-strong proppant into created fractures.

The present invention substantially improves upon the recovery potential beyond that of traditional hydraulic fracturing processes.

A manner of identifying the potential success of oil recovery from subterranean formations is to characterize the permeability characteristics of the formation. Permeability is a measurement of the resistance to fluid flow of a particular fluid through the reservoir and is dependent on the structure, connectivity, and material properties of the pores in a subterranean formation. Permeability can differ in different directions and in different regions.

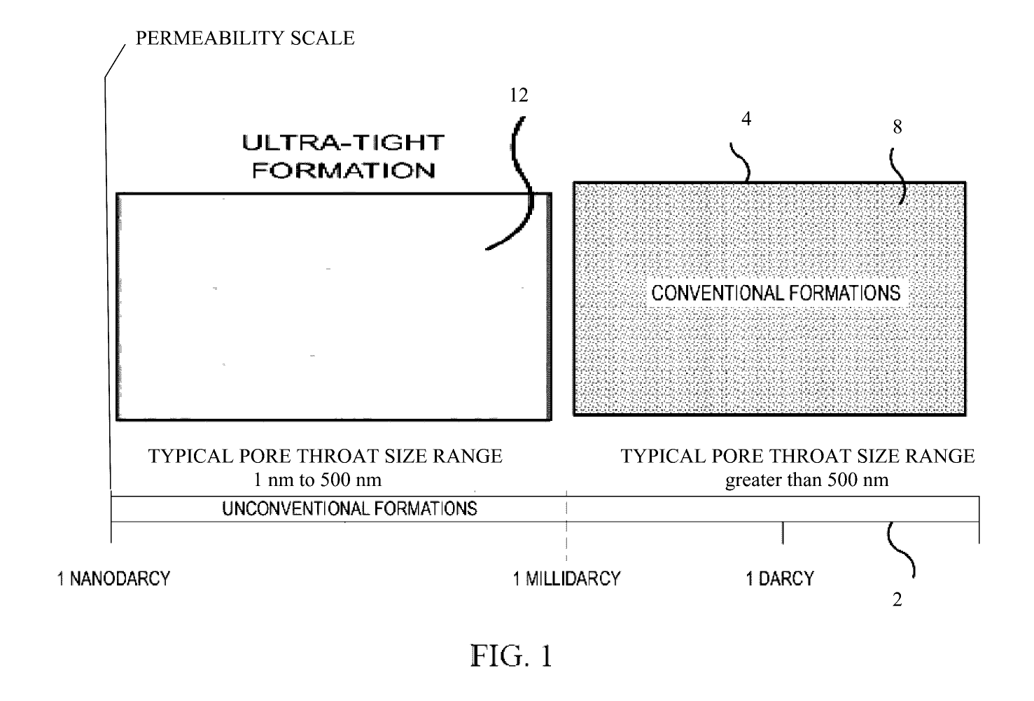

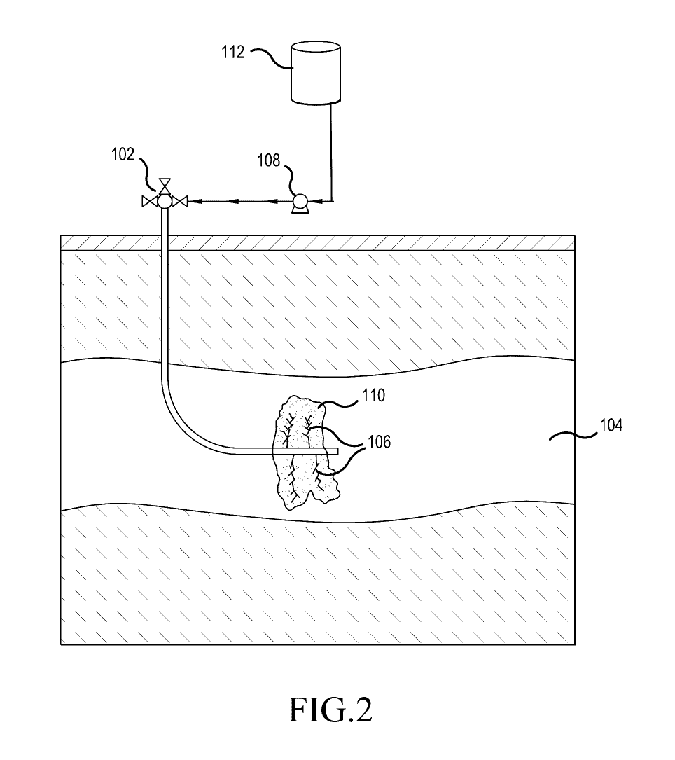

FIG. 1 is an example of an ultra-tight hydrocarbon-bearing subterranean formation 104 as depicted in FIG. 2. An ultra-tight formation is characterized in terms of permeability or permeability scale 2. In a conventional formation 4, the pore throat sizes are relatively large (i.e., greater than 500 nm) such that, when the pores are highly interconnected 8, the formation is conducive to the flow of hydrocarbons. A conventional formation 4 will have a relatively high permeability as compared to ultra-tight formations 12. Ultra-tight formations are also known as unconventional formations, which have a typical pore throat size of 1 to 500 nm.

Permeability can be defined using Darcy's law and can often carry units of m², Darcy (D), or milliDarcys (mD).

Some reservoirs have regions of ultra-tight permeability, where the local permeability may be less than 1 μD, while the overall average permeability for the reservoir may be between 1 μD and 1 mD. Some reservoirs may have regions of ultra-tight or tight permeability with typical permeability of less than 1 mD in a majority of the formation but regions of the formation with high permeability greater than 1mD and even greater than 1 D, particularly in the case of reservoirs with natural fractures. In other words, permeability can vary within a formation. As such, in the present invention, the formation may be better defined in terms of median pore throat diameter.

In the present invention, a hydrocarbon-bearing subterranean formation with a matrix permeability of less than a stated value means a formation with at least 90% of the formation having an unstimulated well test permeability below that stated value. However, at least 95%, at least 97%, at least 98%, or at least 99% of the formation may have an unstimulated well test permeability below that stated value.

In one aspect, the present invention is applicable to hydrocarbon-bearing subterranean formations having a matrix permeability of 1 mD or less, but the formation may have a matrix permeability of less than 0.1 mD or less than 1 μD.

In another aspect, the present invention is applicable to a poorly consolidated conventional reservoir. In this case, the matrix permeability is 10 D or less.

Fracturing techniques may be used to provide a means to increase the injectivity of a formation when the reservoir has low permeability characteristics. Fracturing techniques may also be used as a means of injecting fluid when the reservoir has low permeability characteristics.

The term “fracturing” refers to the process and methods of breaking down a hydrocarbon-bearing subterranean formation and creating a fracture (i.e., the rock formation around a well bore) by pumping fluid at very high pressures in order to increase production rates from a hydrocarbon-bearing subterranean formation.

One embodiment of the present invention is directed to a method of fracturing or frac-packing a subterranean formation. FIG. 2 is an example of a hydrocarbon recovery system comprising a well bore 102 connected to the subterranean formation 104, an injection apparatus 108 connected to the well bore 102, and at least one storage container 112 in fluid communication with the injection apparatus 108. The storage container 112 may be a storage tank or a truck. In this embodiment, a well bore 102 may be drilled in a hydrocarbon-bearing subterranean formation 104 with a matrix permeability of 100 mD or less, 1 mD or less, less than 0.1 mD, or less than 1 μD. In the alternative, the subterranean formation 104 may be defined by its median pore throat diameter wherein the subterranean formation has a median pore throat diameter of greater than 500 nm, less than 500 nm, greater than 50 nm, less than 50 nm, or greater than 10 μm. For example, the median pore diameter may be 1 nm to 500 nm. In another embodiment, an existing well bore 102 can be utilized in a method for restimulating a hydrocarbon-bearing subterranean formation 104 with a matrix permeability of 100 mD or less, 1 mD or less, less than 0.1 mD, or less than 1 μD. In the alternative, the subterranean formation 104 may be defined by its median pore throat diameter wherein the subterranean formation has a median pore throat diameter of greater than 500 nm, less than 500 nm, greater than 50 nm, less than 50 nm, or greater than 10 μm. The well bore 102 can be a single wellbore, operational as both an injection and production wellbore, or alternatively, the wellbore can be distinct injection and production wellbores. The well bore 102 may be conventional or directionally drilled, thereby reaching the formation 104, as is well known to one of ordinary skill in the art. The well bore 102 is approximately horizontal in the formation.

The subterranean formation 104 can be stimulated in order to create fractures 106 in the subterranean formation 104. Specifically, the subterranean zone 104 is fractured with a fracturing fluid to form fractures 106. The fractures may be 50-2000 ft in length and 10-500 ft in height.

Then, a proppant slurry is pumped into the fractures 106 of the subterranean zone 104. A slurry refers to a semiliquid mixture containing at least a particulate solid material and water or other liquid. The proppant slurry comprises ultra-light, ultra-strong proppant.

Next, the pressure from pumping the proppant slurry into the fractures 106 is released to form propped fractures.

Then, in situ hydrocarbons are recovered from an influence zone 110 in the subterranean formation through the well bore 102. This step may take greater than one month, preferably greater than three months, more preferably greater than six months.

The phrase “in situ hydrocarbons” is defined as hydrocarbons residing in the subterranean formation prior to placing the wellbore in the subterranean formation.

The porosity of the reservoir is involved in determining the volume of liquid needed, location of the wellbores, and recognition of the effects obtainable with the present method. The term porosity refers to the percentage of pore volume compared to the total bulk volume of a rock. A high porosity means that the rock can contain more hydrocarbons per volume unit. The saturation levels of oil, gas, and water refer to the percentage of the pore volume that is occupied by oil or gas. An oil saturation level of 20% means that 20% of the pore volume is occupied by oil, while the rest is gas or water.

The injection pressure for injecting the fluids of the present invention is preferably above the initial reservoir pressure for at least a portion of the injection but is not required to be above the initial reservoir pressure for the entire injection period.

The ultra-light, ultra-strong proppant materials of the present invention can be in the form of spherical particles (i.e., beads) and can have a density close to the density of water to promote the optimal distribution and localization of proppant particles in hydraulic fractures. Despite the low density, the proppant materials retain a very high crush strength, which inhibits the formation of fines that adversely impact oil and gas permeability. Proppant material refers to a material suitable for keeping an induced hydraulic fracture open during or following a fracturing treatment.

The ultra-light, ultra-strong proppant materials of the present invention may comprise spherical particles comprising one or more materials selected from the group consisting of oxides, nitrides, oxynitrides, borides, and carbides. The ultra-light, ultra-strong proppant may have a specific gravity between 1.0-3.0 and a crush strength of 10,000 psi or higher.

The spherical particles may have any specific gravity suitable for induced hydraulic fracturing applications. Suitable specific gravities can be close to the specific gravity of water (i.e., 1). The specific gravity may be 1.0 to 3.0, 1.0 to 2.8, 1.0 to 2.6, 1.0 to 2.4, 1.0 to 2.2, 1.0 to 2.0, 1.0 to 1.7, or about 1.0. In other embodiments, the specific gravity may be about 1.1 to 2.8, 1.4 to 2.6, or about 1.6 to 2.2. Specific gravity refers to the ratio of the density of a substance to the density of water having the same volume as the substance.

By having a specific gravity of 3.0 or less, more preferably 1.7 or less, the ultra-light, ultra-strong proppant will settle slower compared to conventional sand and ceramic proppants of higher specific gravity (i.e., 2.6 or more). As such, the method of the present invention improves vertical distribution of proppants and conductivity. The proppants of the present invention will be transported further into the subterranean zone, which improves the lateral distribution of proppants and conductivity. In addition, lighter proppants can be transported at higher proppant concentrations during stimulation to reduce the volumes of fracturing fluid and stimulation time. Higher proppant coverage allows for increased well-spacing and fewer wells.

The spherical particles can have any crush strength suitable for induced hydraulic fracturing applications. For example, the spherical particles may have a crush strength of 10,000 psi or higher, 10,250 psi or higher, 10,500 psi or higher, 10,750 psi or higher, 11,000 psi or higher, 11,250 psi or higher, 11,500 psi or higher, 11,750 psi or higher, 12,000 psi or higher, 12,250 psi or higher, 12,500 psi or higher, 12,750 psi or higher, 13,000 psi or higher, 13,250 psi or higher, 13,500 psi or higher, 13,750 psi or higher, or 14,000 psi or higher. The crush strength refers to a proppant pack level crush resistance measured by a testing procedure in accordance with ISO 13503-2 (2006). In this test, a specified volume of proppant material is crushed in a test cell, and the amount of fines produced is quantified for a given applied stress. Crush strength is then defined as the stress level at which an acceptable amount of fines are produced, which is typically less than 5 to 10% fines.

By having a crush strength of 10,000 psi or higher, the ultra-light, ultra-strong proppant will yield higher conductivity and permeability of the propped fractures. The optimum distribution of proppant conductivity will increase hydrocarbon production.

The spherical particles may have any porosity suitable to attain the desired crush strength and specific gravity. For example, the spherical particles may have a porosity of about 10 to 60%, 13 to 57%, 16 to 54%, 19 to 51%, 22 to 48%, 25 to 45%, 28 to 42%, 31 to 39%, or 34 to 36%. Porosity refers to the measure of void space in a material and is represented as a percentage of the volume of voids in the total volume of the material. A material with 0% porosity have no voids, and a material with a porosity of 60%, for example, has one or more void spaces comprising 60% of the total volume of the material. The spherical particles may also have a hollow core.

The spherical particles may have any size suitable to attain the desired crush strength, specific gravity, and fracture particle distribution. For example, the spherical particles may have a diameter of about 0.1 to 1.7 mm, about 0.1 to 1.6 mm, 0.2 to 1.6 mm, 0.3 to 1.6 mm, 0.4 to 1.6 mm, 0.5 to 1.5 mm, 0.6 to 1.4 mm, 0.7 to 1.3 mm, 0.8 to 1.2 mm, or about 0.9 to 1.1 mm. In other embodiments, the spherical particles may have a diameter of about 0.3 to 0.7 mm. In some embodiments, at least about 80% of the spherical particles may have a diameter within 20% of the average diameter of the spherical particles.

In some embodiments, the spherical particles may have a sphericity of about 0.7 to 1.0, about 0.8 to 1.0, or about 0.9 to 1.0. Sphericity refers to how close a proppant particle approaches the shape of a sphere. Sphericity is calculated as the ratio of the surface area of a sphere with the same volume as the given particle to the surface area of the particle.

The spherical particles may have any suitable composition. More specifically, the spherical particles may comprise one or more materials selected from the group consisting of oxides, nitrides, oxynitrides, borides, and carbides.

An oxide refers to a chemical compound that contains at least one oxygen atom and one other element. The oxides may be SiO₂, Al₂O₃, Fe₂O₃, CaO, MgO, FeO, Fe₃O₄, MnO₂, MnO, Na₂O, SO₃, K₂O, TiO₂, V₂O₅, Cr₂O₃, SrO, ZrO₂, 3Al₂O₃2SiO₂, 2Al₂O₃SiO₂, Ca₂Mg(Si₂O₇), Ca₂SiO₄, yttria-stabilized zirconia (YSZ), or CaCO₃. Preferably, the oxides may be SiO₂, Al₂O₃, Fe₂O₃, CaO, MgO, FeO, Fe₃O₄, MnO, yttria-stabilized zirconia (YSZ), or CaCO₃.

A nitride refers to a chemical compound that contains at least one nitrogen atom and one other element. The nitrides may be Li₂SiN₂, CaSiN₂, MgSiN₂, or Si₃N₄.

An oxynitride refers to a chemical compound that contains at least one oxygen atom, one nitrogen atom, and one other element. The oxynitrides may be Si_{6-z}Al_{z}O_{z}N_{8-z} where 0<z<5.

A boride refers to a chemical compound that contains at least one boron atom and one other less electronegative element. The borides may be MgB₂.

A carbide refers to a chemical compound that contains at least one carbon atom and one other less electronegative element. The carbides may be SiC.

The spherical particles may include a plurality of oxides, nitrides, oxynitrides, borides, and carbides. The spherical particles may include a combination of one or more of oxides, nitrides, oxynitrides, borides, and carbides. The spherical particles may have magnetic properties.

The proppant material may also comprise one or more additives. An additive refers to a substance that is added. Any additives suitable for forming proppant particles of the desired composition can be used. The additives may include C, Al, Si, Mg, K, Fe, Na, B, O, N, ZrO₂, Y₂O₃, and compounds thereof, volcanic ash, and aluminum dross. Volcanic ash refers to particles of pulverized rock, minerals, and volcanic glass created during volcanic eruptions. Aluminum dross refers to a by-product of an aluminum smelting process and typically contains Al₂O₃, residual Al metal, and other species.

The proppant material may also comprise a coating on the spherical particles that may be an organic, ceramic, or nitride material. The coating may promote the containment of fines formed as the result of fracture stresses crushing the spherical particles in operation. Suitable organic materials include, but are not limited to, phenolic polymers and polyurethane.

In some embodiments, the proppant material may include spherical particles comprising a material than can be an oxide, nitride, oxynitride, boride, or carbide. The spherical particles may have a specific gravity between 1.0-3.0, a crush strength of at least about 10,000 psi, a porosity of about 10 to 60%, a diameter of about 0.1 to 1.7 mm, and a sphericity of about 0.7 to 1.0. The oxide may be SiO₂, Al₂O₃, Fe₂O₃, CaO, MgO, FeO, Fe₃O₄, MnO, yttria-stabilized zirconia (YSZ), or CaCO₃. The nitride may be Li₂SiN₂, CaSiN₂, MgSiN₂, or Si₃N₄. The oxynitride may be Si_{6-z}Al_{z}O_{z}N_{8-z} where 0<z<5. The boride may be MgB₂. The carbide may be SiC. The spherical particles may include a coating comprising a material that may be an organic, ceramic, or nitride material.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of fracturing a subterranean zone surrounding a well bore, comprising the steps of:
fracturing the subterranean zone with a fracturing fluid to form fractures;
pumping proppant slurry comprising ultra-light, ultra-strong proppant into the fractures of the subterranean zone; and
releasing pressure after pumping to form propped fractures.

2. The method of claim 1, wherein the ultra-light, ultra-strong proppant has a specific gravity between 1.0-3.0 and a crush strength of 10,000 psi or higher.

3. The method of claim 1, wherein the subterranean zone is a reservoir that requires hydraulic fracturing to produce at commercial rates.

4. The method of claim 1, wherein the subterranean zone has a matrix permeability of 1 mD or less.

5-8. (canceled)

9. A method of frac-packing a subterranean zone surrounding a well bore, comprising the steps of:
fracturing the subterranean zone with a fracturing fluid to form fractures;
pumping proppant slurry comprising ultra-light, ultra-strong proppant into the fractures of the subterranean zone; and
releasing pressure after pumping to form propped fractures.

10. The method of claim 9, wherein the ultra-light, ultra-strong proppant has a specific gravity between 1.0-3.0 and a crush strength of 10,000 psi or higher.

11. The method of claim 9, wherein the subterranean zone is a poorly consolidated zone.

12. The method of claim 9, wherein the subterranean zone has a matrix permeability of 10 D or less.

13-16. (canceled)
